(19) United States
(12) Patent Application Publication
(10) Pub. No.: US 2008/0192598 A1
(43) Pub. Date: Aug. 14, 2008

(54) Recording System For Setting Write Strategy

(75) Inventors: Avinash Jayaraman, Singapore (SG); Venkata Ramana Vangala, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,131

(22) PCT Filed: Apr. 7, 2006
(86) PCT No.: PCT/IB2006/051073

§ 371 Date: Oct. 10, 2007

(30) Foreign Application Priority Data
Apr. 15, 2005 (EP) 05102989.0

(51) Int. Cl. G11B 7/00

(52) U.S. Cl. 369/47.39

(57) ABSTRACT

A recording device writes and reads marks that represent information. A radiation source (22) is controlled for writing the marks according to a write strategy on a record carrier (11) arranged according to a predefined recording format. The recording format defines pre-recorded disc information including a disc type identifier and disc recording parameters. The device has a control unit (20) for setting the write strategy, a strategy table (31) containing strategy data sets, each strategy data set containing parameters defining a respective, preset write strategy, and a lookup table (32) for containing disc type entries, each disc type entry being retrievable based on a disc type identifier and indicating one of the strategy data sets. The control unit (20) is arranged for detecting an actual disc type identifier from the actual disc information, and setting the write strategy based on an applicable strategy data set retrieved from the strategy table in dependence on the actual disc type identifier and the lookup table.

The invention relates to a device for recording information on a record carrier of a removable type arranged according to a predefined recording format, the recording format defining disc information to be provided on the record carrier before use, the disc information including a disc type identifier and disc recording parameters, the device comprising a head for generating a beam of radiation from a radiation source for writing a pattern of marks and for reading the disc information, radiation source control means for controlling the radiation source during said writing according to a write strategy, and a control unit for setting the write strategy in dependence on actual recording conditions that include actual disc information from an actual record carrier present in the device.

The invention further relates to a method of controlling a radiation source during writing a pattern of marks representing information on a record carrier of a removable type arranged according to a predefined recording format, the recording format defining disc information to be provided on the record carrier before use, the disc information including a disc type identifier and disc recording parameters, the method comprising controlling the radiation source during said writing according to a write strategy and setting the write strategy in dependence on actual recording conditions that include actual disc information from an actual record carrier.

A method and apparatus for recording information on a record carrier are known from US2003/0151994. The record carrier is of a recordable type and has a track for recording information, e.g. a spiral shaped track on a disc shaped carrier indicated by a wobbled pregroove. The device comprises a drive unit for rotating the record carrier. For scanning the track an optical head is positioned opposite the track by a positioning unit, while the record carrier is rotated. The head has a laser and optical elements for generating a beam of radiation for writing marks and intermediate spaces. The length of a mark or space has a nominal value of a predetermined number of units of length, usually called a run length measured in channel bits, and the marks and spaces constitute a pattern of marks digitally representing the information according to a modulation code. The device has a control unit for controlling the laser power according to a writing strategy. In such a writing strategy the laser power and a pattern of pulses are controlled according to the run length of the marks to be recorded, taking into account the properties of the record carrier. The record carrier is arranged according to a predefined recording format, for example DVD-R, which recording format defines disc information to be provided on the record carrier before use. The disc information includes a disc type identifier and disc recording parameters, which parameters are intended to set the write strategy. The document describes setting the write strategy according to recording speeds, which requires a test recording and measurements for correction of the parameters at the required speed. For determining the write strategy test the recordings, and measurements of deviations of the marks, such as jitter measurements, are used to detect the quality of the recorded pattern of marks. A history of the write strategy is recorded on the record carrier. A next time the disc is inserted in a drive the write strategy for previous recording speeds is available from the history. The known system of setting of the write strategy has the following disadvantage. When a new record carrier is inserted, or a record carrier that has been used in a different drive, the write strategy has to be set using said test recordings and measurements, even when the actual disc recording parameters are retrieved. The procedure takes a substantial amount of time, which is problematic for a user who wants to start recording immediately.

It is an object of the invention to provide a recording device and method that provide a control of the laser source according to a write strategy while reducing the delay time required after a record carrier has been inserted.

For this purpose, according to a first aspect of the invention, the device for recording as described in the opening paragraph, comprises a strategy table containing strategy data sets, each strategy data set containing parameters defining a respective, preset write strategy, a lookup table for containing disc type entries, each disc type entry being retrievable based on a disc type identifier and indicating one of the strategy data sets, the control unit being arranged for detecting an actual disc type identifier from the actual disc information, and setting the write strategy based on an applicable strategy data set retrieved from the strategy table in dependence on the actual disc type identifier and the lookup table.

For this purpose, according to a second aspect of the invention, the method as described in the opening paragraph comprises providing a strategy table containing strategy data sets, each strategy data set containing parameters defining a respective, preset write strategy, providing a lookup table for containing disc type entries, each disc type entry being retrievable based on a disc type identifier and indicating one of the strategy data sets, detecting an actual disc type identifier from the actual disc information, and setting the write strategy based on an applicable strategy data set retrieved from the strategy table in dependence on the actual disc type identifier and the lookup table.

The measures have the effect that, when a record carrier is presented that has not been used before in the device, a suitable write strategy is retrieved from the strategy table based on the disc identifier. Hence the required strategy is found quickly. It is noted that the current approach advantageously results in a practical balance between startup time and optimizing the write strategy, in particular by selecting a sufficiently good write strategy instead of finding the best possible writing strategy requiring a long period of time, or rejecting a large number of discs as being non recordable due to unreliable disc recording parameters.

The invention is also based on the following recognition. First the disc identifier provides a way of quickly recognizing a disc type that has been used before in the current drive, even when the actual disc is still blank. Prior, known devices may use the actual disc recording parameters of the blank disc. The inventors have seen that such approach may be unreliable. In practice it has been detected that the disc recording parameters, although prescribed by the recording format, do not always provide a good recording quality when applied in an actual drive/disc combination. By using the lookup table based on the disc identifier, a successful write strategy can be selected from the strategy table, when the actual disc is of a type included in the tables.

In an embodiment of the device, the strategy data sets are based on a grouping of disc recording parameters for different types of record carrier according to the recording format, in a particular case the recording format defining a one time recordable medium. This has the advantage that only a limited number of groups are required for covering a large population of available disc types. The required data is found by reading the disc recording parameters of the population, and clustering the disc types having substantially similar disc recording parameters. The lookup table may be formed by including entries for each of the disc type identifiers and indicating the respective write strategy for the group. In practice the approach is suitable for write once discs, such as DVD+R.

In an embodiment of the device, the strategy data sets are based on selected parameter values for disc recording parameters, the parameter values being selected in accordance with a range of values for different types of record carrier according to the recording format, in a particular case the recording format defining a rewritable medium. This has the advantage that a large population of available disc types is covered by a limited number of parameters that are variable within said ranges. The inventors have seen that, even for the large population, some parameters are substantially constant and others are only varying over said limited ranges. Hence a limited number of strategy data sets of combinations of a few parameter values selected in said ranges proves to be sufficient to cover the population. In practice the approach is suitable for rewritable discs, such as DVD+RW.

In an embodiment of the device, the control unit is arranged for, after setting the write strategy based on the applicable strategy data set, determining a quality measure of marks recorded according to the write strategy as set, and, if the quality measure is worse than a quality threshold, retrieving actual disc recording parameters from the actual disc information and setting a write strategy based on the actual disc recording parameters. By detecting the quality measure, such as jitter or bit error rate, the result of the write strategy is verified. When the quality measure is below the quality threshold, a further procedure is started. The device may retrieve the actual disc recording parameters and set a write strategy based thereon. This has the advantage that, even when the disc type identifier is unreliable, the quality of recording is verified, and a fall back to the disc recording parameters is provided.

In an embodiment of the device, the device comprises a strategy adjustment table containing strategy adjustment entries, each strategy adjustment entry being retrievable based on a disc type identifier and each strategy adjustment entry containing adjustments for the disc recording parameters of the respective disc type, and the control unit is arranged for, if the actual disc type identifier corresponds to a strategy adjustment entry, retrieving actual disc recording parameters from the actual disc information, and setting a write strategy based on the actual disc recording parameters and adjustments from said corresponding entry. The adjustment table comprises known corrections for a write strategy based on the disc recording parameters from the record carrier. The correction may be established during fine tuning of a required disc/drive combination. Advantageously manufacturers of a drive or disc can guarantee that the combination provides the best possible write strategy which has been determined off line. In a further embodiment the control unit is arranged for, determining a quality measure of marks recorded according to the write strategy as set, and, if the quality measure is better than a quality threshold, proceeding to recording information based on the write strategy as set. It is noted that accessing the adjustment table is preferably before, but may also be applied after, accessing the lookup table.

In an embodiment of the device, the control unit is arranged for determining if the actual disc type identifier is not included in the lookup table, subsequently setting write strategies from the strategy table and determining a quality measure of marks recorded according to each write strategy as subsequently set, until the quality measure is better than a quality threshold, and adding a disc type entry to the lookup table, the entry corresponding to the actual disc type identifier and indicating the strategy data set corresponding to the write strategy as currently set. This has the effect that the lookup table is dynamically filled during the actual use of the device. Advantageously the lookup table will be filled with the actual disc types that are inserted in the device, and new disc types that appear on the market are automatically added.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

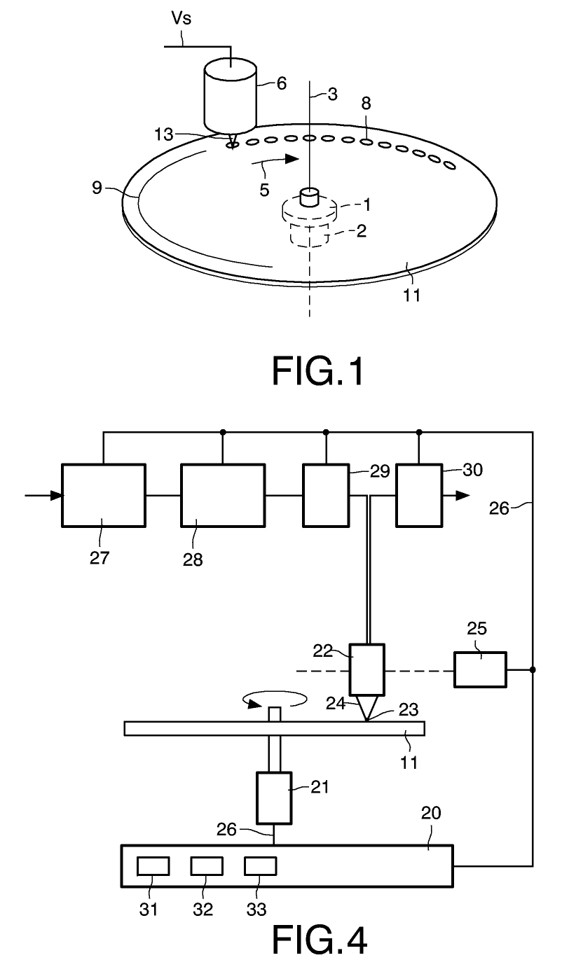

FIG. 1 shows schematically recording on an optical record carrier,

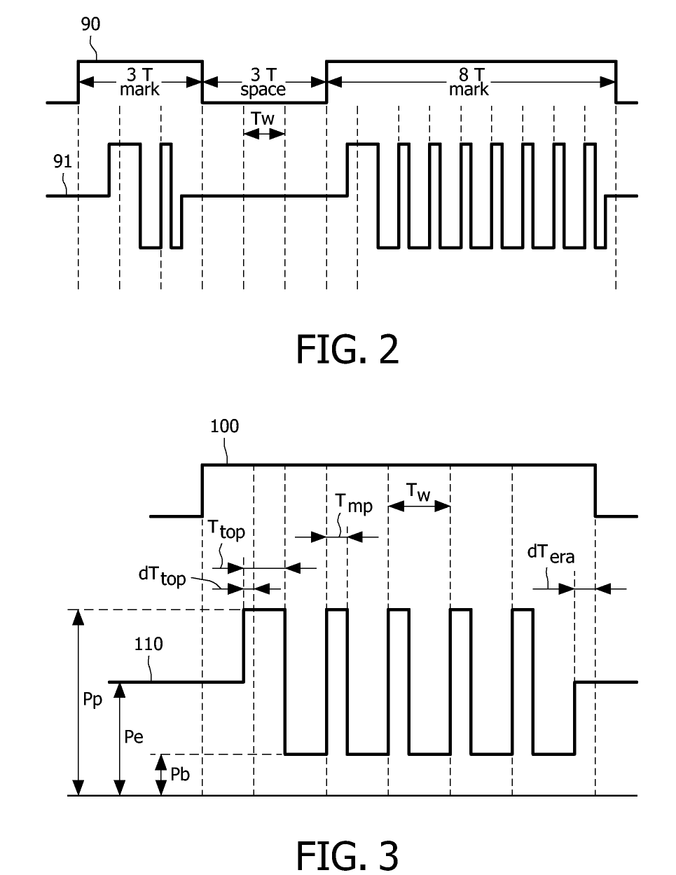

FIG. 2 shows a digital information signal representing information to be recorded on a record carrier,

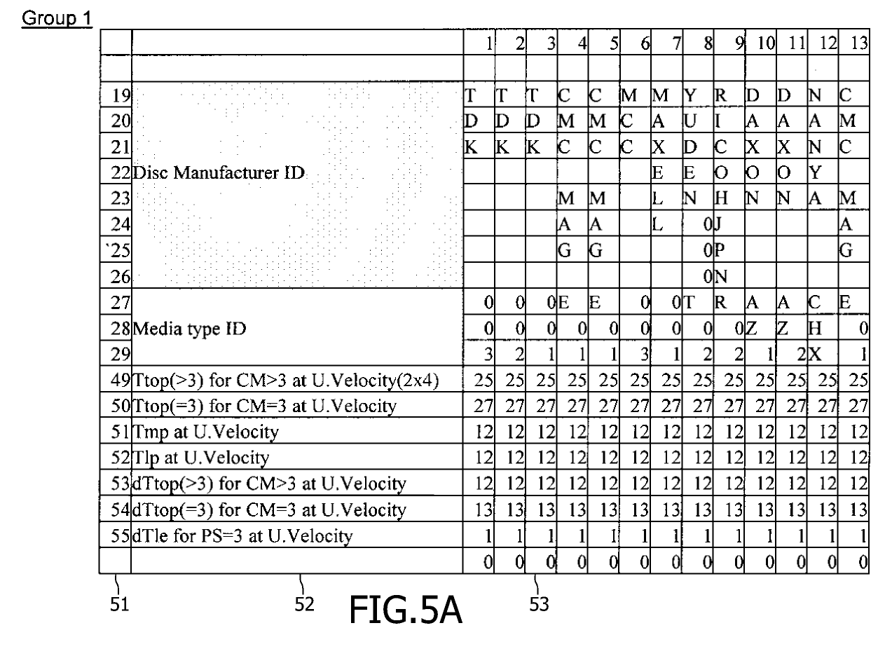

FIG. 3 shows a digital information signal and write strategy parameters,

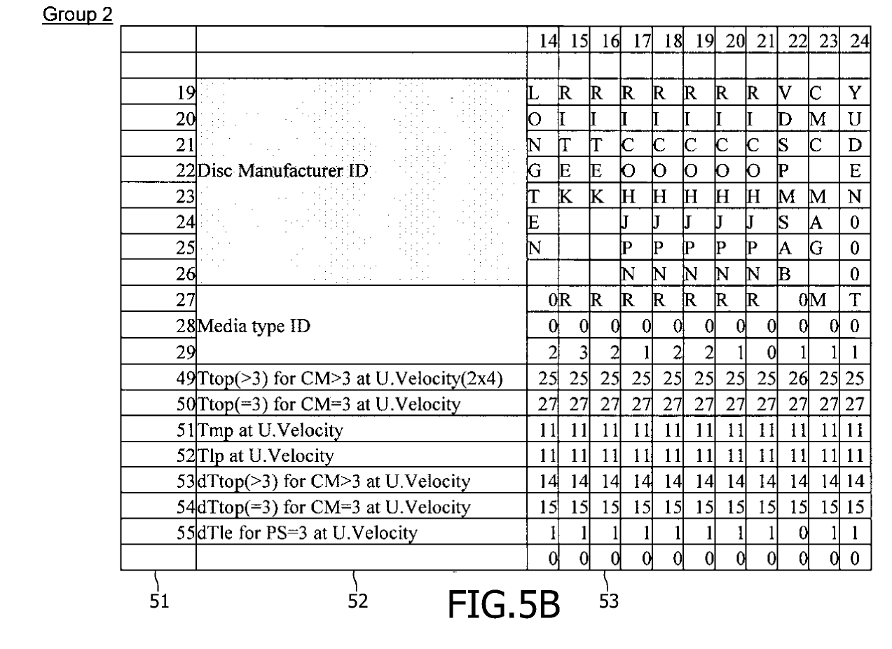

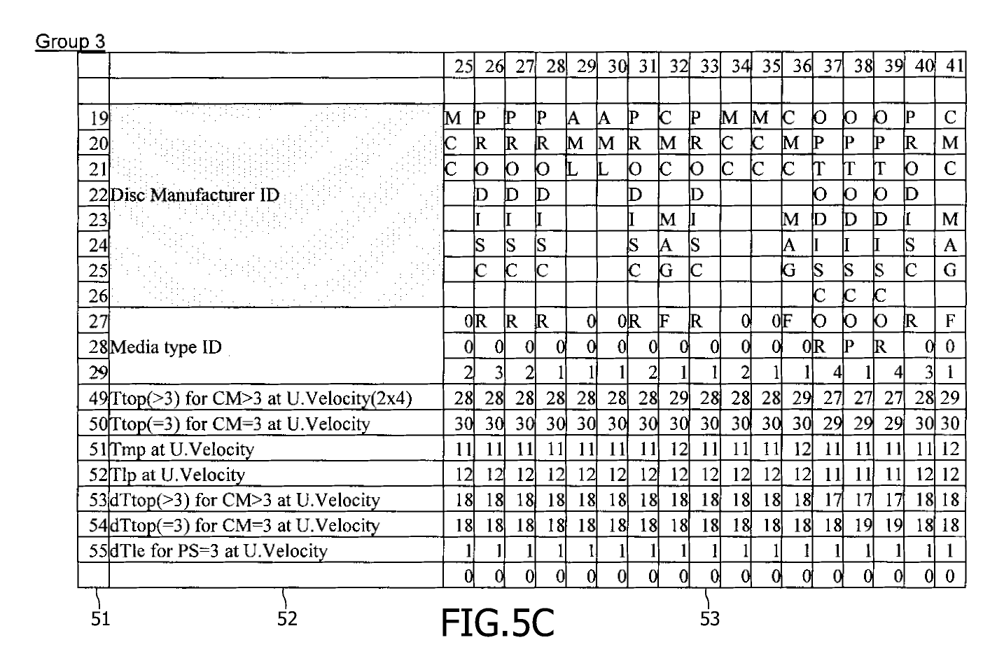

FIG. 4 shows a recording device, FIG. 5 shows a grouping of record carriers for determining a write strategy table, FIG. 5A showing a first group, FIG. 5B showing a second group, and FIG. 5C showing a third group,

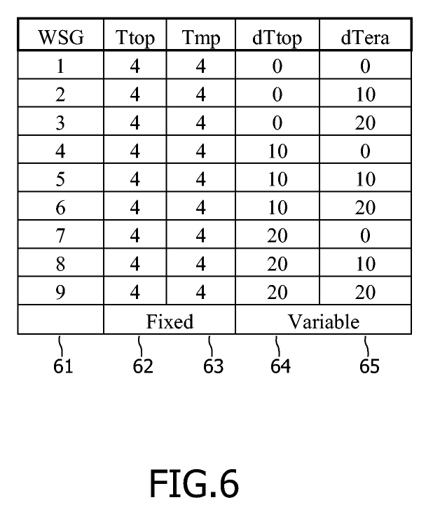

FIG. 6 shows a write strategy table,

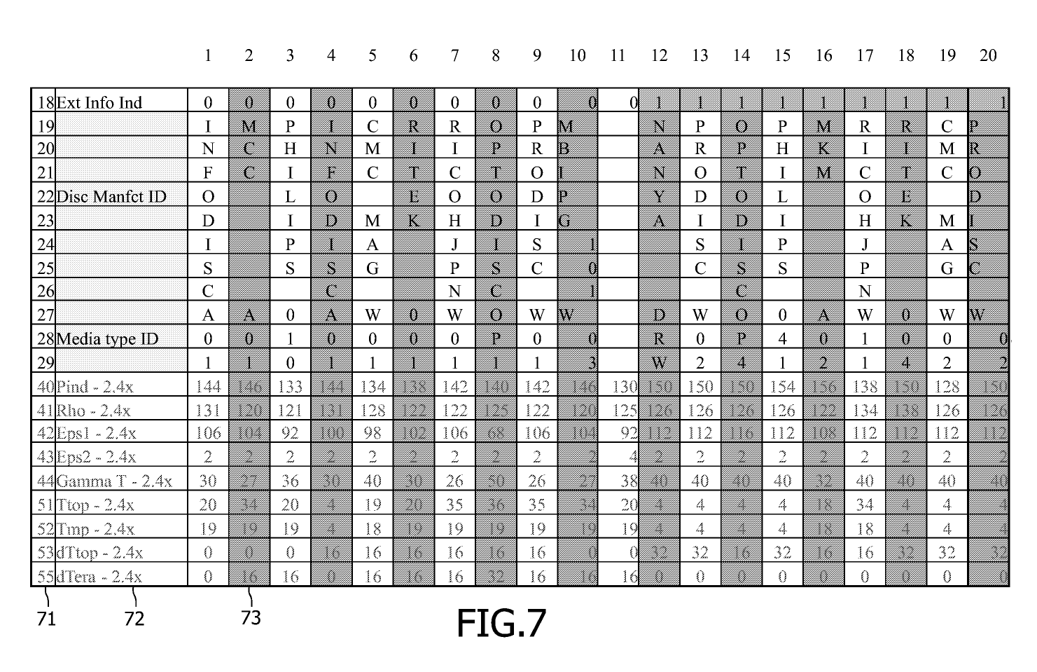

FIG. 7 shows an overview of record carriers for determining ranges of parameters for a write strategy table, and

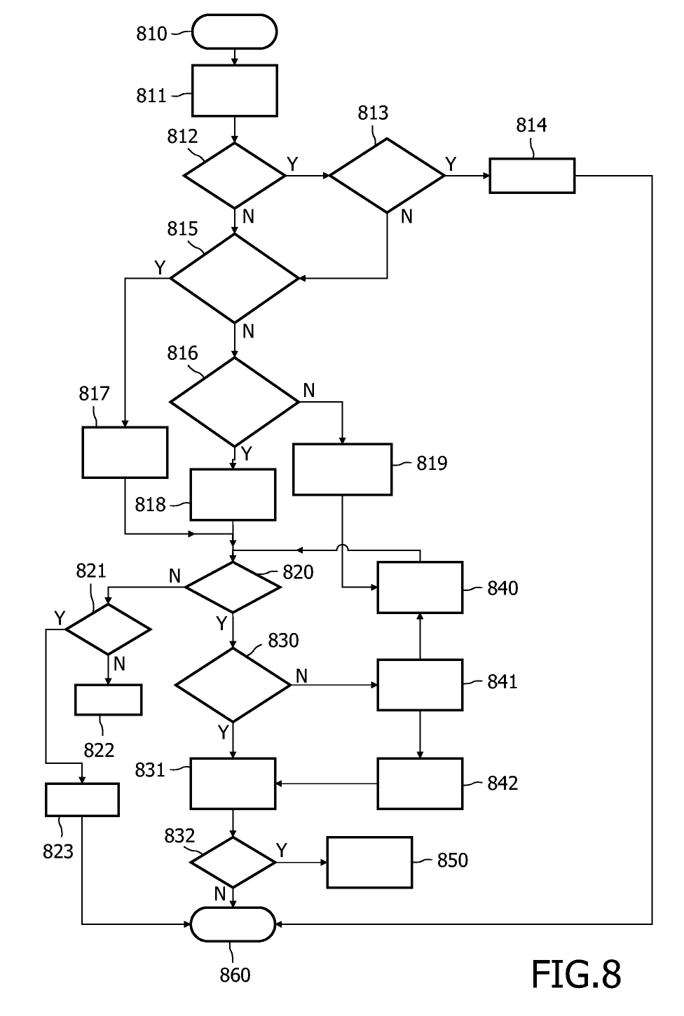

FIG. 8 shows a flowchart of a write strategy setting.

Corresponding elements in different Figures have identical reference numerals.

FIG. 1 shows schematically recording on an optical record carrier. A recording device comprises a turntable 1 and a drive motor 2 for rotating a disc shaped record carrier 11 about an axis 3 in a direction indicated by an arrow 5. The record carrier has a track 9 for recording marks 8, the track being located by a servo pattern for generating servo tracking signals for positioning an optical write head 6 opposite the track. The servo pattern may for example be a shallow wobbled groove, usually called a pre-groove, and/or a pattern of indentations, usually called pre-pits or servo pits. The record carrier 11 comprises a radiation-sensitive recording layer which upon exposure to radiation of sufficiently high intensity is subjected to an optically detectable change, such as for example a change in reflectivity, for forming marks 8 and intermediate spaces constituting a recorded pattern representing information. In the pattern each element has a nominal run length expressed in units called channel bits. The run lengths represent the information according to a modulation scheme usually called channel code. An example of the optical record carrier is a DVD. Further details about the DVD disc can be found in reference: ECMA-267: 120 mm DVD—Read-Only Disc—(1997).

The radiation-sensitive layer may comprise, for example, a thin metal layer which can be altered or removed locally by exposure to a laser beam of comparatively high intensity. Alternatively, the recording layer may consist of another material such as a radiation sensitive dye (the media usually being called recordable and named R) that changes color due to the radiation, or a phase-change material (the media usually being called rewritable and named RW), whose structure can be changed from amorphous to crystalline or vice versa under the influence of radiation. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material.

The optical write head 6 is arranged opposite the track 9 of the (rotating) record carrier. The optical write head 6 comprises a radiation source, for example a solid-state laser, for generating a write beam 13. Controlling the write power for creating a mark or space of a specified length in channel bits is adapted to the type of disc (e.g. material), the recording conditions (e.g. speed) and pattern of marks that has to be recorded, which is called a write strategy (WSG). In high density recording sophisticated write strategies are implemented, e.g. controlling the write power in dependence of the length of the mark to be written and/or size of the preceding space. The result of the writing and quality of the marks is determined by a procedure called optimum power control (OPC) that usually records marks and measures a quality parameter. For example known OPC procedures for DVD+R (see ECMA 349) may be based on jitter measurement and for DVD+RW (see ECMA-337) may be based on gamma measurement.

The record carrier 11 is arranged according to a predefined recording format, e.g. DVD+R or DVD+RW, which recording format defines disc information to be provided on the record carrier before use. The disc information includes a disc type identifier and disc recording parameters. The disc type identifier may include a Disc Manufactures ID and/or a Media Type ID, examples being shown in FIG. 5.

For writing the intensity of the write beam 13 is modulated by a control signal Vs according to the write strategy. For recordable discs the intensity of the write beam 13 varies between a write power, which is adequate to bring about detectable changes in the optical properties of the radiation-sensitive record carrier for forming a mark, and a low (or zero) cooling power, which does not bring about any detectable changes for creating an intermediate area in between the marks further called space. For rewritable discs at least one further power level is chosen, e.g. a power level for erasing any preceding recorded marks called an erase power.

For reading the recording layer is scanned with a beam 13 whose intensity is at a reading level of a constant intensity which is low enough to preclude a detectable change in optical properties. During scanning the read beam reflected from the record carrier is modulated in conformity with the information pattern being scanned.

In optical systems, such as for example a DVD+RW system, disc information indicative of a recording process is stored in a modulated track (often referred to as Address-in-Pregroove or ADIP). The disc information stored in the ADIP comprises values of disc recording parameters for the recording process, also referred to as write strategy parameters. Besides the recording parameters, the ADIP may also comprise, for example, a disc type identifier including information regarding the disc manufacturer, the disc media type, and the disc product revision number.

FIG. 2 shows a digital information signal representing information to be recorded on a record carrier. The value of the digital information signal 90 represents the lengths of marks to be recorded in the recording layer of the record carrier 11. The vertical dashed lines indicate transitions in a reference clock signal belonging to the digital information signal. One period of this reference clock, also called the channel bit period, is indicated by Tw. The digital information signal to be recorded is converted into a control signal 91 which controls the power of the pulsed radiation beam, where it is assumed that the power of the pulsed radiation beam is proportional to the corresponding level of the control signal 91. The relation between the marks to be recorded and the corresponding pulsed radiation beam is defined by the so-called write strategy. In the embodiment shown in the Figure, a so-called (N−1) write strategy is applied. By such a (N−1) write strategy, a mark in the digital information signal 90 having a length of nT (that is, a time length of n times Tw) is converted into a series of n−1 pulses in the control signal 91. For example, a 8T marks is converted into a sequence of 7 pulses and a 3T mark is converted into a sequence of 2 pulses.

FIG. 3 shows a digital information signal and write strategy parameters. The digital information signal 100 to be recorded is converted into a control signal 110 by a (N−1) write strategy resulting in a sequence of 5 pulses. These pulses are modulated between a write power level Pp and a bias power level Pb. The power level before and after the sequence of pulses is at an erase power level Pe, which corresponds to an erase power level of the radiation beam capable of erasing previously written marks between the marks being written.

The actual shape of the sequence of pulses (that is, the wave shape) depends on a number of recording parameters dTtop, Ttop, Tmp and dTera, where Ttop defines the duration of the first pulse in a sequence, Tmp defines the duration of the pulses except for the first pulse in a sequence, dTtop (initial delay parameter) defines the start of the first pulse relative to a transition of the reference clock signal, and dTera (final delay parameter) defines the end of the sequence of pulses relative to a transition of the reference clock signal. These parameters are called write strategy data, and are set according to the invention as described below. It is to be noted that the write strategy shown in FIGS. 2 and 3 is just an example (used for DVD+RW), other strategies may contain different parameters for defining pulse timing, power levels or profiles, pulse shapes, etc.

FIG. 4 shows a recording device for writing and/or reading information on a record carrier 11 of a type which is recordable, for example DVD-R (see ECMA-359), or re-writable such as DVD+RW or BD (Blu-ray Disc, see http://www.blu-raydisc.com). The device is provided with scanning means for scanning the track on the record carrier which means include a drive unit 21 for rotating the record carrier 11, a head 22, a positioning unit 25 for coarsely positioning the head in the radial direction on the track, and a control unit 20. The head comprises a radiation source, e.g. a laser diode, an optical system and additional circuitry of a known type for generating a radiation beam 24. The radiation beam is guided through optical elements focused to a radiation spot 23 on a track of the information layer of the record carrier. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. For reading the radiation reflected by the information layer is detected by a detector of a usual type, e.g. a four-quadrant diode, in the optical head for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the optical head, the positioning unit 25 and the read processing unit 30. The device comprises write processing means for processing the input information to generate a write signal to drive the optical head, which means comprise an input unit 27, and a formatter 28 and a laser power unit 29. The control unit 20 controls the recording and retrieving of information and may be arranged for receiving commands from a user or from a host computer. The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates, for performing the writing and/or reading functions. The control unit 20 may also be implemented as a state machine in logic circuits. It is noted that the device may be arranged for recording on multilayer media. The focusing, tracking, and control unit 20 are arranged for detecting, and operating on, the respective recording layer, and applying settings for recording on a selected layer.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to units of information, which are passed to the formatter 28. The read processing unit 30 may comprise suitable audio and/or video decoding units. It is noted that the invention is very suitable for audio/video recorders, as time-to-record is critical for users.

The formatter 28 is for adding control data and formatting and encoding the data according to the recording format, e.g. by adding error correction codes (ECC), interleaving and channel coding. Further the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed to the laser power unit 29.

The laser power unit 29 receives the formatted data indicating the marks to be written and generates a laser power control signal which drives the radiation source in the optical head. The laser source is controlled according to the write strategy settings as described hereafter, in particular power and pulse pattern such as pulse length and delays are controlled in dependence of marks of different lengths.

The control unit 20 is arranged for setting the write strategy in dependence on actual recording conditions that include actual disc information from an actual record carrier present in the device. Furthermore, the device comprises a memory containing a strategy table 31 that contains strategy data sets, each strategy data set containing parameters defining a respective, preset write strategy, and a lookup table 32 for containing disc type entries, each disc type entry being retrievable based on a disc type identifier and indicating one of the strategy data sets. The strategy table 31 is filled based on parameters for suitable write strategies for a respective type of record carrier. It is noted that the device may have strategy tables for respective, different recording formats, and select the appropriate table after detecting the recording format. The lookup table 32 contains a list of disc type identifiers and corresponding pointers to suitable write strategies from the write strategy table 31.

The control unit 20 is further arranged for detecting an actual disc type identifier from the actual disc information, and setting the write strategy based on an applicable strategy data set retrieved from the strategy table 31 in dependence on the actual disc type identifier and the lookup table 32. The actual disc type identifier is compared to the entries available in the lookup table. If none of the entries match, a fallback write strategy setting procedure, or default write strategy, may be applied, or an error message may be generated.

There is a need for an algorithm, which can record reliably on any medium (with or without Aux Bytes indicating specific versions of the disc recording information). The aim is to provide maximum compatibility of media for discs of a selected recording format but of different brands (called a population). In a practical study according to the invention, over 50 media of DVD+R and DVD+RW were collected. Some of them have the same manufacturing and media ID but are branded differently. Various options of the algorithm for accommodating differences in the population of media are described below.

In an embodiment the device comprises a strategy adjustment table 33, also called ADJ table, which table contains strategy adjustment entries, each strategy adjustment entry being retrievable based on a disc type identifier and each strategy adjustment entry containing adjustments for the disc recording parameters of the respective disc type. The control unit 20 is arranged for detecting if the actual disc type identifier corresponds to a strategy adjustment entry. If so, the actual disc recording parameters are retrieved from the actual disc information. Adjustments are retrieved from the entry in the ADJ table. The write strategy is set based on the actual disc recording parameters and adjustments thereon retrieved from said corresponding entry in the ADJ table.

The control unit 20 may be arranged for determining a quality measure of marks recorded according to the write strategy as set. The quality measure is based on a test recording using the provisional write strategy as set, and may be detecting jitter and/or a bit error rate. If the quality measure is better than a preset quality threshold, the control unit directly proceeds to recording information based on the write strategy as set. If the quality measure is below the preset quality threshold, the control unit proceeds to lookup table as described above. In an alternative embodiment, the lookup table may be accessed first, i.e. before accessing the ADJ table. This allows the device the override a faulty entry is the ADJ table by including an entry in the lookup table.

For a first recording format the strategy data sets are based on a grouping of disc recording parameters for different types of record carrier according to the recording format. The approach below is suitable for a recording format that defines a one time recordable medium, for example DVD+R.

FIG. 5 shows a grouping of record carriers for determining a write strategy table. In the Figure a first column 51 shows an address of disc information units (usually bytes). A second column 52 shows an explanation of the function of the disc information units. The third and following columns 53 show actual values of disc information; the units 19-29 providing a disc type identifier comprising a Disc Manufacturer ID and Media Type ID, and the units 49-55 providing 7 values for disc recording parameters. The tables show values of DVD+R discs, in particular for a speed of 2.4× the nominal speed. An observation of the Write Strategy Parameters in the disc recording information (in ADIP) of the population of media led to the classification of the discs into three broad categories called groups based on the WSG parameters, each group being defined by 7 parameter values. FIG. 5A shows a first group of media having similar WSG parameters, FIG. 5B shows a second group of media having similar WSG parameters, and FIG. 5C shows a third group of media having similar WSG parameters. The groups are entered in a WSG table having 7 values for each WSG as follows (example discs are mentioned for each group):

Group 1→25-27-12-12-12-13-1 (Example: TDK+R 4×)

Group 2→25-27-11-11-14-15-1 (Example: Ricoh+R 4×)

Group 3→28-30-11-12-18-18-1 (Example: Prodisc+R 4×)

The values for each group in the WSG table are based on average or median values for each parameter. The observation according to the invention is that substantially all discs of the respective recording format (recordable disc, DVD+R) can be adequately recorded using these three categories. With this observation made it is decided that these three group strategies are used in the WSG table according to the invention as the different available write strategy options. A default strategy, if any, may be added, e.g. as a fourth entry in the WSG table. For each disc of the sample set an entry may be included in the lookup table. The entry has the disc type identifier and the corresponding group number of the WSG to be used.

A similar approach may be applied to a different recording format. For a recording format for rewritable media such as DVD+RW, the strategy data sets in the WSG table are based on selected parameter values for disc recording parameters. The parameter values are selected in accordance with a range of values for different types of record carrier according to the recording format. The range of values is based on a practical set of rewritable media, e.g. as shown in FIG. 7. For setting the WSG some of the disc recording parameters are fixed to a single value, and some parameters are dynamically adjusted based on either disc recording parameters retrieved from the record carrier (if available), or based on default values and/or measurements during writing or in a separate test and measure procedure called optimum power control (OPC). However, a number of parameters are selected and parameter values are included in said write strategy table based on the ranges that substantially cover the population of media.

In an embodiment the write strategy is set based on a selected number of variable parameters, the selected parameters including at least one of a initial delay parameter (dTₜₒₚ) that defines a delay of a beginning of a first pulse in a pulse pattern for writing a mark, and a final delay parameter (dTₑᵣₐ) that defines a delay of an erase level after the last pulse in the pulse pattern. A table based on ranges [0-32] for both delay parameters is shown in FIG. 6.

FIG. 6 shows a write strategy table. In a first column 61 a write strategy label is entered for the write strategy entry on the respective row. In a second column 62 values for a disc recording parameter Ttop are shown; in a third column 63 values for a disc recording parameter Tmp are shown; in a fourth column 64 values for a disc recording parameter dTtop are shown; in a fifth column 65 values for a disc recording parameter dTera are shown. The values in second column 62 and third column 63 are values for a disc recording parameter Ttop and Tmp are shown. The table shows values for DVD+RW discs. In the current example a range has been established only for dTtop and dTera in the fourth and fifth columns. In other examples ranges for other parameter may be included, and further combinations may be added to, or excluded from, the WSG table based on the practical occurrence of such combinations.

The parameters Ttop and Tmp have been selected to be fixed values. It is noted that the corresponding disc recording parameters may be varying, e.g. as shown in FIG. 7. However, the inventors have seen that a sufficiently good recording quality can be achieved by using fixed values for some parameters. A practical balance between startup time and write strategy optimization is achieved by limiting the number of parameters, and the ranges of variation.

When record carriers according to a specific recording format require substantial variations of further parameters to achieve acceptable quality, such parameters may be varied also over a limited range. In an embodiment the user might activate a further optimization procedure, e.g. as a special command, or as a background process, in which further parameters are varied for further improving the WSG. The result may be stored in a separate table, or may be added to the ADJ table.

FIG. 7 shows an overview of record carriers for determining ranges of parameters for a write strategy table. In the Figure a first column 71 shows an address of disc information units (usually bytes). A second column 72 shows an explanation of the function of the disc information units. The third and following columns 73 show actual values of disc information; the units 19-29 providing a disc type identifier (ID) comprising a Disc Manufacturer ID and Media Type ID, and the units 40-55 providing 9 values for disc recording parameters. The tables show values of DVD+RW discs, in particular for a speed of 2.4× the nominal speed. Different values for other speeds may be used when appropriate, depending on the capabilities of the recording device and the medium. An observation of the table shows that in the case of DVD+RW the discs cannot be segregated in groups like DVD+R. The strategies over the different media do not have a substantial commonality. After studying the media, the following approach for setting the write strategy was adopted.
Fix Ttop and Tmp=8 ns.
(Following most of WSG of the 4×+RW discs, corresponding to 50% duty cycle)
Take Epsilon 1, Rho, Gamma Target, and Pind values from the disc (if available). If they are not available use preset default values.
Vary the dTtop and dTera values (0, 16 and 32).
   This results in nine strategies as shown in FIG. 6, the table having hexadecimal values. It is noted that the corresponding lookup table has the disc type identifier and the corresponding WSG number for the known discs, e.g. 20 entries for the disc types shown in FIG. 7.

For unknown discs, i.e. discs that are not included in the lookup table, a number of the WSGs in the write strategy table 31 may be applied subsequently. Whichever strategy gives the desired result (i.e. has a sufficient quality of the recorded marks), is used for recording on the media. The chosen strategy and disc type identifier may then be added to the lookup table, which is updated to save time for future recordings. It is noted that when the disc type identifier is not available (e.g. none is provided), the look-up table cannot be updated.

Furthermore, in the event that a dye is changed without changing the disc identifier or a dummy ID is used or copied from a different disc type, in the lookup table the previous entry may be replaced by the new value. Alternatively, two entries are stored and it is detected which entry results in the best write strategy to accommodate both old and new media.

FIG. 8 shows a flowchart of a write strategy setting. It is to be noted that the flowchart shows a combination of several of the above embodiments. At start 810 a disc is inserted. A startup procedure 811 detects a recording format and disc data like DVD+RW disc, single layer and the applicable recording speed, e.g. 2.4×. Disc information of the actual disc present is retrieved. In next step 812 the ADJ table is accessed. If the ADJ table has an entry corresponding to the disc type identifier, the disc recording parameters from the actual disc are combined with the adjustment values of the ADJ table. A test 813 is performed to measure jitter and bit error rate (caller BLER), which are tested against thresholds, e.g. jitter<10 and BLER<20. If the quality measurements are better than the thresholds (in this example lower), in step 814 the ADJ selected WSG is made final and the write strategy procedure proceeds to END 860, and subsequently user data recording may be performed as required. If the ADJ detection is not successful, or not included, the lookup table is accessed.

In a lookup test 815 it is detected if the disc type identifier is included in the lookup table. If so, in step 817, the WSG indicated in the lookup table is accessed in the WSG table, and subsequently used. An OPC may be performed to confirm the validity of the WSG.

If the lookup table does not have the disc type identifier, in step 816 tries to retrieve actual disc recording parameters from the record carrier. If available, a WSG may be based on the actual disc recording parameters, and an OPC may be performed, in step 818, to confirm the validity of the WSG. If not available, in step 819, default or predefined values may be set for a number of WSG parameters (such as, for DVD+RW: Pind, Rho, Gamma Target, and Epsilon 1; and for DVD+R: Pind and Beat Target). In step 840 the available strategies from the WSG table may be subsequently tested by performing OPC.

From any of the preceding WSG the OPC is tested in step 820, if not successful in step 821 it is detected if all available WSGs have been tested. If not, in step 822, a next WSG and OPC is performed in an OPC retry procedure. If all WSGs have failed, in step 823 an error message is generated (e.g. Disc ERR).

If the OPC of the current WSG is successful, the values for jitter and/or bit error rate are tested against thresholds, e.g. jitter<10 and BLER<20. If, in step 830, the quality measurements are worse than the thresholds (in this example higher), in step 841 the quality values (jitter and BLER) are temporarily stored in a buffer, and a next WSG is selected from the WSG table in step 840. If no further strategy entries are available, in step 842 an evaluation is made based on the stored values. The best available WSG is selected based on Jitter and BLER, and possible further quality measurements or detected values.

In an embodiment, the evaluation of step 842 may result in selecting the write strategy corresponding to the quality measure closest to the quality threshold based on further quality values. For example, if the procedure is based on jitter, the BLER value may be included in the further evaluation. Alternatively a further quality measure may be measured, e.g. signal strength or modulation of a read signal, and selecting the write strategy may be based on the further quality measure. In a further embodiment other parameters may be varied of at least one write strategy that has been tested before and came close to the quality threshold, and a corresponding quality measure may be detected. Finally, a record carrier error message may be generated if none of the stored quality measures is above a reduced quality threshold that is lower than the quality threshold.

If, in step 830 the quality measurements are better than the thresholds (in this example lower), or after step 842, the final WSG is confirmed to be used for recording after ending the WSG procedure in step 860. In step 832 it is verified if the disc type identifier is available, and if so the lookup table is updated in step 850.

For the implementation of the invention the initialization procedure for a record carrier now includes a Jitter and BLER measurement to be performed in an OPC calibration area. A Look-up table will be maintained in a memory, for example in a system EEPROM or as a separate table, which will contain the disc manufacturing ID, Media type ID and the write strategy, which was found to be optimal. Also a table with WSG parameters is maintained. In a practical example the initialization procedure for a record carrier includes the following:
1. Perform a Startup-Procedure, and detect disc format and recording speed, e.g. DVD+RW 2.4× speed.
2. Check if the disc is in the ADJ table. If it is in the ADJ table then,
   a. Do OPC with the ADJ WSG (ADIP+adjustment factors).
   b. Check if the Measured Jitter and BLER fall within the specified limits.
   Store the jitter and BLER values for comparison.
      i. If the measurement is within the limits then proceed to record with the ADJ strategy. (ADIP+adjustment factors)
      ii. If jitter/BLER is higher than limit then proceed to step 3.
3. Check if the disc is in the Look-Up table. If it is then,
   a. Do OPC with the WSG indicated in the Look-up table. Store the jitter and BLER values for comparison.
   b. Check if the Measured Jitter and BLER fall within the specified limits.
      i. If the measurement is within the limits then proceed to record with the Look-up table WSG.
      ii. If jitter/BLER is higher than limit then proceed to step 4.
4. Check if the ADIP WSG information and Media Parameters are available. If available, then
   a. Do OPC with Default ADIP WSG. Store the jitter and BLER values for comparison.
   b. Check if the Measured Jitter and BLER fall within the specified limits.
      i. If the measurement is within the limits then proceed to record with the default ADIP WSG.
      ii. If jitter/BLER is higher than limit then proceed to step 6.
5. If the media parameters and WSG information is not available, then use preset parameters (e.g. for DVD+RW: Rho, gamma target, epsilon 1 and Pind values) and proceed to step 6.
6. Do OPC with WSG1. Store the jitter and bler values for comparison.
   a. Check if the Measured Jitter and BLER fall within the specified limits.
      i. If the measurement is within the limits then proceed to record with WSG 1. If the Media ID and Manufacturer ID are available then add/update the disc in the Look-up table, so that next time the disc is used it will take lesser time.
      ii. If jitter/BLER is higher than limit then proceed to step 7.
7. Repeat step 6 with next available WSG, and if that also fails the next WSG and so on.
8. If jitter/BLER is higher than limit for all the WSGs, then choose the best of the WSGs. Apply judgment criteria of which is the best—Choose on BLER, or jitter or a combination or a weighted combination. Add/Update the Look-up table with the best WSG if the Media and Manufacturing ID are available.

Although the invention has been explained mainly by embodiments using the DVD+R and DVD+RW, it may be useful as well for other recording formats (DVD-R, DVD-RW, DVD-RAM), dual/multi layer writable media (e.g. DVD+RW DL) or high-density media (e.g. Blu-ray Disc). Also for the record carrier an optical disc has been described, but other media, such as optical card, may be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information on a record carrier (11) of a removable type arranged according to a predefined recording format, the recording format defining disc information to be provided on the record carrier before use, the disc information including a disc type identifier and disc recording parameters,
the device comprising:
a head (22) for generating a beam of radiation from a radiation source for writing a pattern of marks and for reading the disc information,
radiation source control means (29) for controlling the radiation source during said writing according to a write strategy,
a control unit (20 for setting the write strategy in dependence on actual recording conditions that include actual disc information from an actual record carrier present in the device,
a strategy table (31) containing strategy data sets, each strategy data set containing parameters defining a respective, preset write strategy,
a lookup table (32) for containing disc type entries, each disc type entry being retrievable based on a disc type identifier and indicating one of the strategy data sets, the control unit (20) being arranged for
detecting an actual disc type identifier from the actual disc information, and
setting the write strategy based on an applicable strategy data set retrieved from the strategy table in dependence on the actual disc type identifier and the lookup table.

2. Device as claimed in claim 1, wherein the strategy data sets are based on a grouping of disc recording parameters for different types of record carrier according to the recording format, in a particular case the recording format defining a one time recordable medium.

3. Device as claimed in claim 1, wherein the strategy data sets are based on selected parameter values for disc recording parameters, the parameter values being selected in accordance with a range of values for different types of record carrier according to the recording format, in a particular case the recording format defining a rewritable medium.

4. Device as claimed in claim 3, wherein the selected parameters include at least one of a initial delay parameter (dTₜₒₚ) that defines a delay of a beginning of a first pulse in a pulse pattern for writing a mark, and a final delay parameter (dTₑᵣₐ) that defines a delay of an erase level after the last pulse in the pulse pattern.

5. Device as claimed in claim 1, wherein the control unit (20) is arranged for, after setting the write strategy based on the applicable strategy data set,
determining a quality measure of marks recorded according to the write strategy as set, and,
if the quality measure is worse than a quality threshold,
retrieving actual disc recording parameters from the actual disc information and
setting a write strategy based on the actual disc recording parameters.

6. Device as claimed in claim 1, wherein the device comprises
a strategy adjustment table (33) containing strategy adjustment entries, each strategy adjustment entry being retrievable based on a disc type identifier and each strategy adjustment entry containing adjustments for the disc recording parameters of the respective disc type, and
the control unit (20) is arranged for,
if the actual disc type identifier corresponds to a strategy adjustment entry,
retrieving actual disc recording parameters from the actual disc information, and
setting a write strategy based on the actual disc recording parameters and adjustments from said corresponding entry.

7. Device as claimed in claim 6, wherein the control unit is arranged for,
determining a quality measure of marks recorded according to the write strategy as set, and, if the quality measure is better than a quality threshold,
proceeding to recording information based on the write strategy as set.

8. Device as claimed in claim 1, wherein the control unit is arranged for
determining if the actual disc type identifier is not included in the lookup table,
subsequently setting write strategies from the strategy table and
determining a quality measure of marks recorded according to each write strategy as subsequently set, until the quality measure is better than a quality threshold, and
adding a disc type entry to the lookup table, the entry corresponding to the actual disc type identifier and indicating the strategy data set corresponding to the write strategy as currently set.

9. Device as claimed in claim 8, wherein the control unit is arranged for temporarily storing the quality measure for each write strategy as subsequently set, and, if none of the stored quality measures is better than a quality threshold, at least one of
selecting the write strategy corresponding to the quality measure closest to the quality threshold,
determining a further quality measure and selecting a write strategy based on the further quality measure,
varying further parameters of at least one write strategy corresponding to a quality measure close to the quality threshold,
generating a record carrier error message if none of the stored quality measures is above a reduced quality threshold that is lower than the quality threshold.

10. Method of controlling a radiation source during writing a pattern of marks representing information on a record carrier of a removable type arranged according to a predefined recording format, the recording format defining disc information to be provided on the record carrier before use, the disc information including a disc type identifier and disc recording parameters,
the method comprising
controlling the radiation source during said writing according to a write strategy,
setting the write strategy in dependence on actual recording conditions that include actual disc information from an actual record carrier,
providing a strategy table containing strategy data sets, each strategy data set containing parameters defining a respective, preset write strategy,
providing a lookup table for containing disc type entries, each disc type entry being retrievable based on a disc type identifier and indicating one of the strategy data sets,
detecting an actual disc type identifier from the actual disc information, and
setting the write strategy based on an applicable strategy data set retrieved from the strategy table in dependence on the actual disc type identifier and the lookup table.
